(19) United States
(12) Patent Application Publication
(10) Pub. No.: US 2025/0383257 A1
(43) Pub. Date: Dec. 18, 2025

(54) OPTICAL PROBE, INSPECTION OPTICAL MODULE, AND MEASUREMENT SYSTEM

(71) Applicant: Kabushiki Kaisha Nihon Micronics, Tokyo (JP)

(72) Inventor: Michitaka OKUTA, Kanagawa (JP)

(21) Appl. No.: 19/228,437

(22) Filed: Jun. 4, 2025

(30) Foreign Application Priority Data
Jun. 17, 2024 (JP) 2024-097624

(51) Int. Cl. G01M 11/02

(52) U.S. Cl. CPC G01M 11/0214

(57) ABSTRACT

An optical probe includes a medium through which an optical signal propagates; a plano-convex first lens disposed on a first surface of the medium with a bottom surface facing the medium; and a plano-convex second lens which constitutes a compound lens in which a bottom surface of the second lens is connected to the bottom surface of the first lens by aligning an optical axis of the second lens and an optical axis of the first lens. The second lens is embedded in the medium and has a curvature radius of a convex surface larger than that of the first lens. A refractive index of the medium is larger than a refractive index of the compound lens.

### CROSS-REFERENCE TO RELATED APPLICATION

The present application is based on, and claims priority from Japanese Patent Application No. 2024-097624, filed on Jun. 17, 2024, the entire contents of which are incorporated herein by reference.

### TECHNICAL FIELD

The present disclosure relates an optical probe, an inspection optical module, and a measurement system used for measurement of an optical device.

### BACKGROUND

A silicon device (hereinafter, it is also referred to as “optical device”) in which optical signals propagate is formed on a semiconductor wafer using silicon photonics technology. An optical probe and an electrical probe are used to measure the characteristics of an optical device in a state that is formed on a semiconductor wafer. In the measurement using an optical probe, an optical device and an optical probe are aligned to reduce a loss of optical signals propagated through the optical probe.

In the optical measurement and inspection of an optical device, a single-core or multi-core array optical probe is used. For example, a large number of light incidence/emission ends of diffraction grating shapes are arranged at the silicon waveguide ends of the optical device on the upper surface of the semiconductor wafer to perform an alignment of the light incidence/emission ends and the optical probe. In this alignment, a precise position adjustment with multiple degrees of freedom is performed for the optical probe, a position and a direction of the optical axis in the optical probe and light incidence/emission ends and a mode field diameter are adjusted, thereby optically connecting the optical device and the optical probe in a non-contact manner.

### SUMMARY

When the optical transmission path of the optical probe through which the optical signal passes is a single mode, the optical transmission path has a small numerical aperture. Further, since a size of the light incidence/emission ends on which the optical signal of the optical device is incident and emitted is small (about a few μm), a level of error tolerance for alignment of the light incidence/emission ends of the optical device and the tip surface of the optical probe is low. For example, the numerical aperture NA of the single-mode fiber used as the optical probe is small (about 0.1 to 0.13), making it difficult to accurately perform an alignment of the optical device and the optical probe. Furthermore, if the optical signal from the optical device and the optical probe are not aligned in the optical axis direction, the optical signal will be radiated, and the connection efficiency between the optical device and the optical probe will rapidly decrease. Therefore, when performing the positioning in the optical axis direction, for example, a coarse movement position adjustment is performed using actuators capable of adjusting six-axis degrees of freedom (adjusting the position of the XYZ axes and the rotation movement of each axis) in such a way that the optical device and the optical probe are opposed to each other, and then, a precise position adjustment is performed using a light receiving intensity by means of an optical system. As a result, when measuring the optical device, the measurement time becomes longer due to the time required for alignment, and the connection loss increases and fluctuates due to incorrect alignment.

In view of the above problems, an object of the present application to provide an optical probe, an inspection optical module, and a measurement system, capable of suppressing the time required for alignment of an optical device and the optical probe and suppressing an increase and a fluctuation in a connection loss.

An optical probe according to an embodiment includes a medium through which an optical signal propagates; a plano-convex first lens disposed on a first surface of the medium with a bottom surface facing the medium; and a plano-convex second lens having a curvature radius of a convex surface larger than that of the first lens. The first lens and the second lens constitute a compound lens in which a bottom surface of the second lens is connected to the bottom surface of the first lens by aligning an optical axis of the second lens and an optical axis of the first lens. The second lens is embedded in the medium, and a refractive index of the medium is larger than a refractive index of the compound lens.

The embodiment makes it possible to provide an optical probe, an inspection optical module, and a measurement system, capable of suppressing the time required for alignment of an optical device and the optical probe and suppressing an increase and a fluctuation in a connection loss.

### BRIEF DESCRIPTION OF DRAWINGS

FIG. 1 is a schematic diagram illustrating a configuration of an inspection optical module according to an embodiment.

FIG. 2 is a schematic diagram for explaining a ray path of an optical probe according to the embodiment.

FIG. 3 is a schematic diagram for explaining the ray path of the optical probe according to the embodiment.

FIG. 4 is a graph illustrating a relationship between an angular deviation and a distance from an optical axis of an optical signal when a first curvature radius is 10 μm and a second curvature radius is 15 μm.

FIG. 5 is a graph illustrating a relationship between an angular deviation and a distance from an optical axis of an optical signal when the first curvature radius is 5 μm and the second curvature radius is 7 μm.

FIG. 6 is a graph illustrating a shape of a mode field pattern of the optical probe according to the embodiment.

FIG. 7 is a graph illustrating a relationship between a numerical aperture and a beam diameter.

FIG. 8 is a graph illustrating a relationship between a ratio of a mode field diameter and a loss.

FIG. 9A is a graph illustrating a relationship between a numerical aperture and a working distance when the first curvature radius is 5 μm.

FIG. 9B is a graph illustrating a relationship between a numerical aperture and a working distance when the first curvature radius is 10 μm.

FIG. 9C is a graph illustrating a relationship between a numerical aperture and a working distance when the first curvature radius is 15 μm.

FIG. 10 is a schematic diagram illustrating another configuration of the inspection optical module according to the embodiment.

FIG. 11 is a schematic diagram illustrating a configuration of an inspection optical module according to a modification of the embodiment.

FIG. 12 is a schematic diagram illustrating a configuration of a measurement system using an optical probe according to the embodiment.

### DETAILED DESCRIPTION

An embodiment of the present invention will be described below with reference to the drawings. In the following description of the drawings, the same or similar reference numerals are applied to the same or similar parts; however, it should be noted that the drawings are illustrated schematically. The embodiment described below exemplifies a device and a method for embodying an technical idea of the present invention, and in the embodiment of the present invention, the structure, arrangement, and the like of the components are not limited to the following description. The embodiment of the present invention can be variously modified in the scope of claims.

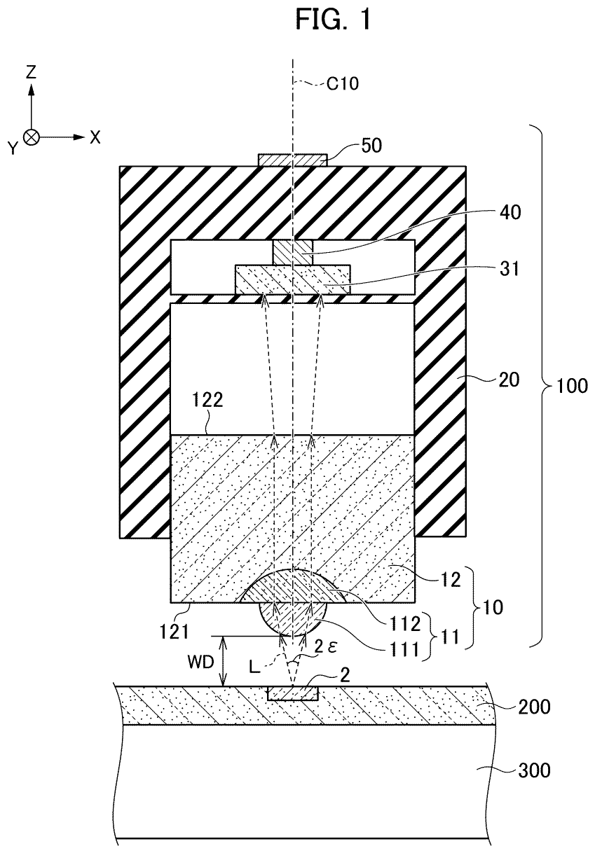

An optical probe 10 according to an embodiment as illustrated in FIG. 1 transmits and receives an optical signal L to and from an optical device 2 formed on a semiconductor wafer 200. FIG. 1 illustrates a case where the optical signal L emitted from the optical device 2 is incident on the optical probe 10.

The optical probe 10 includes a medium 12 through which an optical signal L propagates, a plano-convex first lens 111, and a plano-convex second lens 112 whose curvature radius of the convex surface is larger than that of the first lens 111. The first lens 111 is disposed on a first surface 121 of the medium 12 with the bottom surface facing the medium 12. The second lens 112 constitutes a compound lens 11 in which a bottom surface of the second lens 112 is connected to the bottom surface of the first lens 111 by aligning an optical axis of the second lens 112 with an optical axis of the first lens 111. The second lens 112 is embedded in the medium 12. The refractive index of the medium 12 (hereinafter, it is referred to as “second refractive index n2”) is larger than the refractive index of the compound lens 11 (hereinafter, it is referred to as “first refractive index n1”). That is, n1<n2.

As described above, the compound lens 11 has a configuration in which the bottom surface of the first lens 111 and the bottom surface of the second lens 112 are disposed opposite to each other by aligning the optical axis of the first lens 111 and the optical axis of the second lens 112. An optical axis C10 of the optical probe 10 is an optical axis of the first lens 111 and the second lens 112.

As illustrated in FIG. 1, a direction in which the optical axis C10 of the optical probe 10 extends (hereinafter, it is also referred to as “optical axis direction”) is defined as a Z-axis direction, and a plane surface perpendicular to the Z-axis direction is defined as an XY plane surface. A left-right direction of the page space in FIG. 1 is defined as an X-axis direction, and a direction perpendicular to the page space is defined as a Y-axis direction. In the following description, the X-axis direction, the Y-axis direction, and the Z-axis direction are collectively referred to as “XYZ-axes directions”.

Hereinafter, the curvature radius of the first lens 111 is referred to as the first curvature radius R1, and the curvature radius of the second lens 112 is referred to as the second curvature radius R2. That is, R1<R2. The area of the bottom surface of the second lens 112 is larger than the area of the bottom surface of the first lens 111. In other words, the outer edge of the second lens 112 is positioned outside the outer edge of the first lens 111 when viewed from the optical axis direction. Thus, the compound lens 11 is an asymmetric lens.

The first lens 111 has, for example, the first curvature radius R1 of 5 to 20 μm and an outer diameter of the bottom surface of 10 μm to 30 μm. The second lens 112 has, for example, the second curvature radius R2 of 10 to 40 μm and an outer diameter of the bottom surface of about 10 μm to 50 μm.

The optical signal L propagates through the compound lens 11 and the medium 12 of the optical probe 10. The medium 12 is, for example, a silicon-based material. Hereinafter, the path through which the optical signal L of the optical probe 10 propagates is referred to as the “propagation path” of the optical probe 10.

As illustrated in FIG. 1, the optical probe 10 is supported by a support medium 20 such that the first lens 111 is opposed to the light incidence/emission ends (not illustrated) of the optical device 2 formed on the semiconductor wafer 200. The size of the support medium 20 in the XY directions may be, for example, about 100 μm to 200 μm. The support medium 20 requires miniaturization and precise processing. The material of the support medium 20 is preferably a dielectric material with excellent insulating properties such as ceramic or resin.

The semiconductor wafer 200 is disposed on a stage 300. The semiconductor wafer 200 is fixed to the stage 300 on a prober by vacuum adsorption, for example.

The optical device 2 is a silicon photonics device integrating an optical circuit and an electronic circuit. In the silicon photonics device integrating an optical circuit and an electronic circuit, the optical circuit is immune to electromagnetic induced noise, thereby seeking to increase the operation speed of the circuit, improve the function of the circuit, and reduce the power consumption of the circuit. A large number of silicon photonics devices can be formed on a composite laminated substrate such as an SOI (Silicon ON Insulator) substrate using silicon and quartz, for example, by means of semiconductor microfabrication technology used for manufacturing CMOS integrated circuits. For optical measurement of the optical device 2 formed on the semiconductor wafer 200, a terminal including a diffraction grating at the silicon waveguide end of the optical device 2 may be disposed on the upper surface of the semiconductor wafer 200 and used as a light incidence/emission end for measurement. As illustrated in FIG. 1, the optical signal L emitted from the light incidence/emission end of the optical device 2 travels in the Z-axis direction by disposing the diffraction grating at the light incidence/emission end of the optical device 2.

The optical probe 10 as illustrated in FIG. 1 is combined with an optical element optically connected to the optical probe 10 to constitute an inspection optical module 100. The optical element of the inspection optical module 100 as illustrated in FIG. 1 is a light receiving element 31 disposed to be opposed to a second surface 122, which is one end surface of the propagation path of the medium 12. The compound lens 11 is disposed on a first surface 121, which is the other end surface of the propagation path of the medium 12, and a spherical surface of the first lens 111 is opposed to the light incidence/emission end of the optical device 2. The first lens 111 is optically connected to the light incidence/emission end of the optical device 2 which emits an optical signal L having a radiation angle 2ε. Hereinafter, the first surface 121 opposed to the optical device 2 is also referred to as a “tip surface”. Further, the second surface 122 opposed to the optical element is also referred to as a “base end surface”. The space between the base surface and the light receiving element 31 is a fine space and may be filled with a translucent resin or the like.

The first lens 111 of the optical probe 10 is positioned away from the optical device 2 by the working distance WD along the Z-axis direction. The working distance WD is set to the range within which the optical probe 10 can receive the optical signal L emitted from the optical device 2. The optical signal L emitted from the optical device 2 propagates through the medium 12 after penetrating the compound lens 11.

The base end surface of the propagation path of the optical probe 10 is optically connected to the light receiving element 31 across the space between the medium 12 and the light receiving element 31. At this time, it is preferable to apply a non-reflective coating to the base end surface or to apply a slight inclination to the base end surface, or to apply an anti-reflection coating to the inside of the support medium 20, in order to prevent resonance or stray light caused by the end surface reflection between the base end surface of the medium 12 and the light receiving element 31. In this way, the optical signal L emitted from the optical device 2 is incident on the compound lens 11, propagated through the propagation path of the optical probe 10, and then emitted from the base end surface and incident on the light receiving element 31. For example, the light receiving element 31 photoelectrically converts the optical signal L. The light receiving element 31 is electrically connected to an electrode pad 50 disposed on the outer surface of the support medium 20 via a connection terminal 40 connected to the light receiving element 31. The electric signal output from the light receiving element 31 is transmitted to a measurement device (not illustrated) via the electrode pad 50, and the characteristics of the optical signal L are measured by the measurement device. The light receiving element 31 may be a very small silicon photodiode or an indium gallium arsenide (InGaAs) photodiode depending on the application and usage conditions.

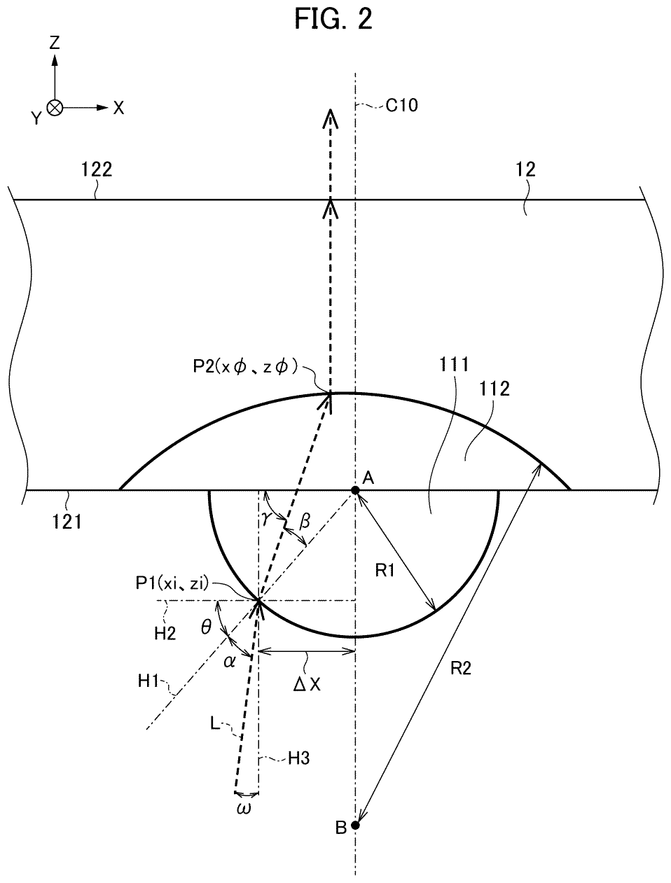

Next, the ray path of the optical signal L incident on the optical probe 10 will be described with reference to FIG. 2. FIG. 2 is an enlarged view of the region including the compound lens 11 and the medium 12. For the sake of clarity, hatching representing a cross section is omitted in FIG. 2. FIG. 2 illustrates an XZ plane surface with the optical axis C10 as the Z axis and the first surface 121 of the medium 12 as the X axis. The same ray path exists in the YZ plane surface as in the XZ plane surface, and since the YZ plane surface has spherical symmetry with respect to the optical axis, the relationship between the ray paths is the same. Therefore, for the sake of simplicity, the following description will be limited to the XZ plane surface.

In FIG. 2, the center of the spherical surface of the first lens 111 on the optical axis C10 is illustrated as a first center point A, and the center of the spherical surface of the second lens 112 is illustrated as a second center point B. The first center point A is the origin of the X axis and the Z axis. The position where the optical signal L passes through the spherical surface of the first lens 111 is defined as a first passing point P1. The first passing point P1 illustrated in FIG. 2 is the position where the optical signal L is incident on the first lens 111. The coordinates of the first passing point P1 are (Xi, Yi, Zi), but denoted as (Xi, Zi) because they are on the XZ plane surface. The first passing point P1 is a position that deviates by ΔX from the optical axis C10 along the X-axis direction. The position where the optical signal L passes through the spherical surface of the second lens 112 is referred to as a second passing point P2. The second passing point P2 is a point where the optical signal L passes through the boundary between the second lens 112 and the medium 12, and the second passing point P2 illustrated in FIG. 2 is a position where the optical signal L is emitted from the second lens 112. The coordinates of the second passing point P2 are (Xφ, Yφ, Zφ), but denoted as (Xφ, Zφ) because they are on the XZ plane surface.

A description will be given to a case where the first passing point P1 at which the optical signal L is incident on the optical probe 10 has deviated from the optical axis C10 in the X-axis direction as an example below. The same applies when the first passing point P1 has deviated from the optical axis C10 in the Y-axis direction.

In order to explain the ray path of the optical signal L, as illustrated in FIG. 2, a straight line passing through the first center point A and the first passing point P1 is defined as a first straight line H1. A straight line passing through the first passing point P1 and parallel to the first surface 121 is defined as a second straight line H2. A straight line passing through the first passing point P1 and parallel to the optical axis C10 is defined as a third straight line H3.

As illustrated in FIG. 2, the angle formed by the traveling direction of the optical signal L before entering the compound lens 11 and the first straight line H1 is defined as a, and the angle formed by the traveling direction of the optical signal L and the second straight line H2 is defined as θ. When the deviation angle of the optical axis of the optical signal L with respect to the optical axis C10 is @ (hereinafter, it is also referred to as “angular deviation”), the optical signal L is incident on the compound lens 11 at an incident angle of α±ω.

After the optical signal L is incident on the compound lens 11 at the first passing point P1, the optical axis of the optical signal L changes according to the difference between the refractive index of the space between the optical probe 10 and the optical device 2 and the refractive index of the compound lens 11. Specifically, the traveling direction of the optical signal L changes such that the angle formed by the optical axis of the optical signal L and the optical axis C10 becomes smaller inside the compound lens 11.

As illustrated in FIG. 2, the refractive angle formed by the traveling direction of the optical signal L inside the compound lens 11 and the first straight line H1 is defined as β, and the angle formed by the traveling direction of the optical signal L and the first surface 121 is defined as γ. The refractive angle β is expressed by the following equation (1):

$$β = {sin}^{- 1} ( sin ( α \pm ω ) / n 1 ) \qquad ( 1 )$$

After the optical signal L travels from the compound lens 11 to the medium 12 at the second passing point P2, the optical axis of the optical signal L changes according to the difference between the refractive index of the compound lens 11 and the refractive index of the medium 12. Specifically, the optical axis of the optical signal L gets closer to the optical axis C10 in parallel inside the medium 12. At this time, if the optical axis of the optical signal L incident on the medium 12 is parallel to the optical axis C10 and the distance from the optical axis C10 to the optical axis of the optical signal L (hereinafter, it is also referred to as “position deviation”) is smaller than ΔX, the optical axis of the optical signal L is corrected. In other words, if the position of the optical axis of the optical signal L propagated through the medium 12 gets closer to the Z-axis, that is, to the optical axis C10 of the optical probe 10, than the X-coordinate of the first passing point P1, the optical axis of the optical signal L is corrected.

The coordinates of the first passing point P1 are (Xi, Yi) and the coordinates of the second passing point P2 are (Xφ, Yφ) in the XY plane surface as viewed from the Z-axis direction. The traveling direction of the optical signal L is expressed by Y=a×X+b as a linear equation. The inclination a of this straight line is (Yi−Yφ)/(Xi−Xφ), and the intercept b is Yi−aXi. Further, when the distance of the first passing point P1 from the optical axis C10 is defined as a first position deviation DLi, DLi=(Xi²+Yi²)^{1/2} is satisfied. When the optical axis, which is the Z axis, moves to the position of the intercept b, the relationship illustrated in FIG. 2 is obtained.

Even though the inspection optical module 100 has the optional angular deviation @ and the first position deviation DLi, the ray path relationship illustrated in FIG. 2 can be obtained by moving the position of the Z axis by the intercept b in the Y axis direction. Therefore, the optical axis of the optical signal L can be corrected. For example, the positional relationship between the optical probe 10 and the optical signal L can be optimized by a fine motion adjustment of the inspection optical module 100 that adjusts one axis in the Y-axis direction while monitoring the received light intensity, thereby making it possible to correct the angular deviation ω and the first position deviation DLi. The same applies in the case of the X-axis direction, and a fine-motion adjustment of the inspection optical module 100 that adjusts one axis in the X-axis direction may be performed. Whether the fine-motion adjustment is performed in the Y-axis direction or the X-axis direction may be selected optionally.

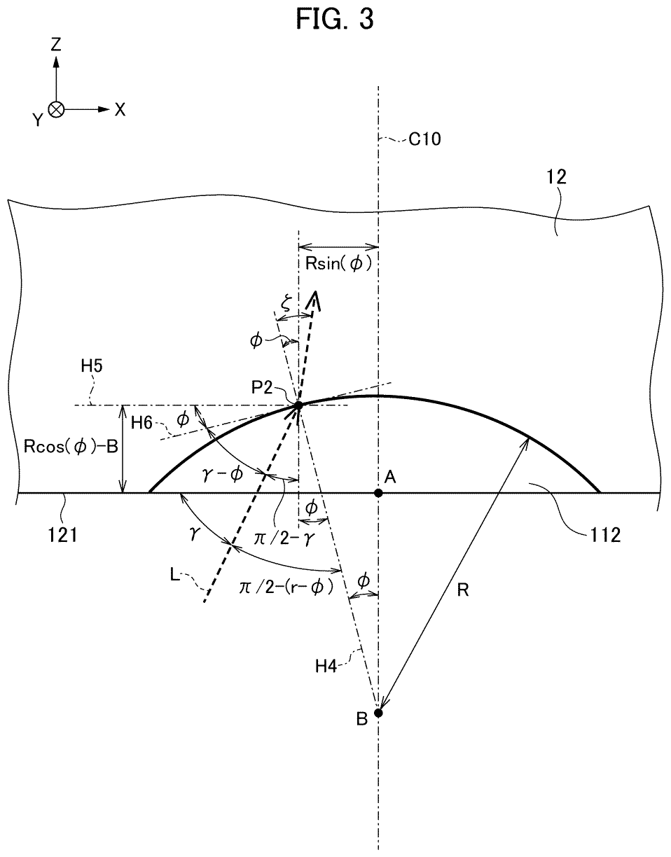

Next, a ray path of the optical signal L propagating from the second lens 112 to the medium 12 will be described with reference to FIG. 3. FIG. 3 is an enlarged view of the connection region between the second lens 112 and the medium 12. For the sake of clarity, hatching representing a cross section is omitted in FIG. 3. FIG. 3 illustrates an XZ plane surface with the optical axis C10 as the Z axis and the first surface 121 of the medium 12 as the X axis.

In order to explain the ray path of the optical signal L, as illustrated in FIG. 3, a straight line passing through the second center point B and the second passing point P2 is defined as a fourth straight line H4. A straight line passing through the second passing point P2 and parallel to the first surface 121 is defined as a fifth straight line H5. The tangent of the spherical surface of the second lens 112 at the second passing point P2 is defined as a sixth straight line H6.

As illustrated in FIG. 3, the angle formed by the optical axis C10 and the fourth straight line H4 is defined as q. In addition, the angle formed by the traveling direction of the optical signal L traveling inside the medium 12 and the fourth straight line H4, that is, the refractive angle of the optical signal L incident on the medium 12 is defined as ζ.

The incident angle of the second lens 112 on the spherical surface is φ+ (π/2−γ). Using the refractive angle, the following equation (2) is satisfied:

$$n 1 \times sin ( π / 2 - γ + φ ) = n 2 \times sin ( ζ ) \qquad ( 2 )$$

Under the condition that λ=φ is satisfied for the refractive angle λ, the optical axis of the optical signal L incident on the medium 12 is parallel to the optical axis C10. That is, with respect to the function F(φ) illustrated in the following equation (3) derived from the equation (2), the condition for correcting the optical axis of the optical signal L parallel to the optical axis C10 can be obtained by obtaining the value of φ satisfying the equation F(φ)=0:

$$F ( φ ) = ( π / 2 - γ + φ ) - {sin}^{- 1} \{ n 2 / n 1 \times sin ( φ ) \} \qquad ( 3 )$$

φ is the angle formed by the optical axis C10, and the fourth straight line H4 passing through the second center point B, which is the center of the spherical surface of the second lens 112, and the second passing point P2.

The optical axis of the optical signal L can be corrected by setting φ so as to satisfy the equation F(φ)=0 when the angle formed by the traveling direction of the optical signal L in the compound lens 11 and the first surface 121 is defined as γ, the refractive index of the compound lens is defined as n1, and the refractive index of the medium 12 is defined as n2. That is, the optical axis of the optical signal L in the medium 12 becomes parallel to the optical axis C10.

From the value of φ satisfying the equation F(φ)=0, the emission coordinates (Xφ, Zφ) of the second passing point P2 at which the optical signal L travels from the second lens 112 to the medium 12 are set. The spherical surface of the second lens 112 is expressed by X²+(Z−B)²=R². Thus, the following equations (4) and (5) are satisfied where the Z coordinate of the second center point B is Bz:

$${X}_{φ} = R \times sin ( φ ) \qquad ( 4 )$$

$${Z}_{φ} = R \times cos ( φ ) - Bz \qquad ( 5 )$$

If Xφ<Xi, the position of the optical axis of the optical signal L gets closer to the optical axis C10 of the optical probe 10 at the second passing point P2 rather than at the first passing point P1. That is, the position and angle of the optical axis of the optical signal L are corrected so as to be closer to the optical axis C10.

Under the same condition as described above, the emission coordinates (Xφ, Yφ) at which the optical signal L in the XY plane surface emits from the compound lens 11 can be obtained from the incident coordinates (Yi, Zi) at which the optical signal L in the YZ plane surface is incident on the compound lens 11. If the distance from the optical axis C10 to the second passing point P2 in the XY plane surface is defined as a second position deviation DLφ, DLφ=(Xφ²+Yφ²)^{1/2} is satisfied, and DLφ<DLi is satisfied because the optical axis of the optical signal L is corrected.

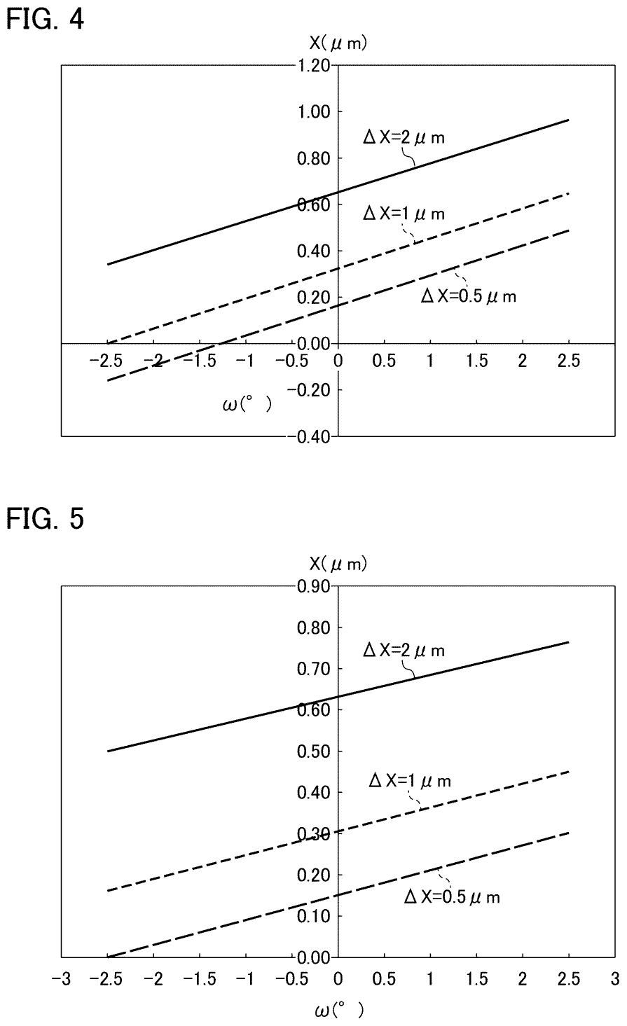

FIGS. 4 and 5 illustrate the relationship between the angular deviation @ and the position deviation X in the medium 12. In the graphs illustrated in FIGS. 4 and 5, a case is described in which ΔX, which is the amount of deviation in the X-axis direction (hereinafter, it is also referred to as “optical axis deviation”) between the optical axis of the optical signal L emitted from the optical device 2 and the optical axis C10 of the optical probe 10, is 0.5 μm, 1 μm, and 2 μm. The graphs illustrated in FIGS. 4 and 5 are obtained by calculating F(φ)=0 using the Newton method when the first refractive index n1 is 1.44 and the second refractive index n2 is 3.48. FIG. 4 illustrates a relationship between the angular deviation @ and the position deviation X when the first curvature radius R1 is 10 μm and the second curvature radius R2 is 15 μm. FIG. 5 illustrates a relationship between the angular deviation @ and the position deviation X when the first curvature radius R1 is 5 μm and the second curvature radius R2 is 7 μm.

As illustrated in FIGS. 4 and 5, even if the incident angle deviates by @=+2.5 degrees, the position deviation X is smaller than the optical axis deviation ΔX under all conditions. In other words, it can be seen that the position of the optical axis of the optical signal L is corrected by the optical probe 10 so as to be closer to the optical axis C10. Even if the angular deviation of +@ occurs, it is converted into a position deviation. The position deviation and the optical axis deviation in the Y-axis direction are the same as those in the X-axis direction.

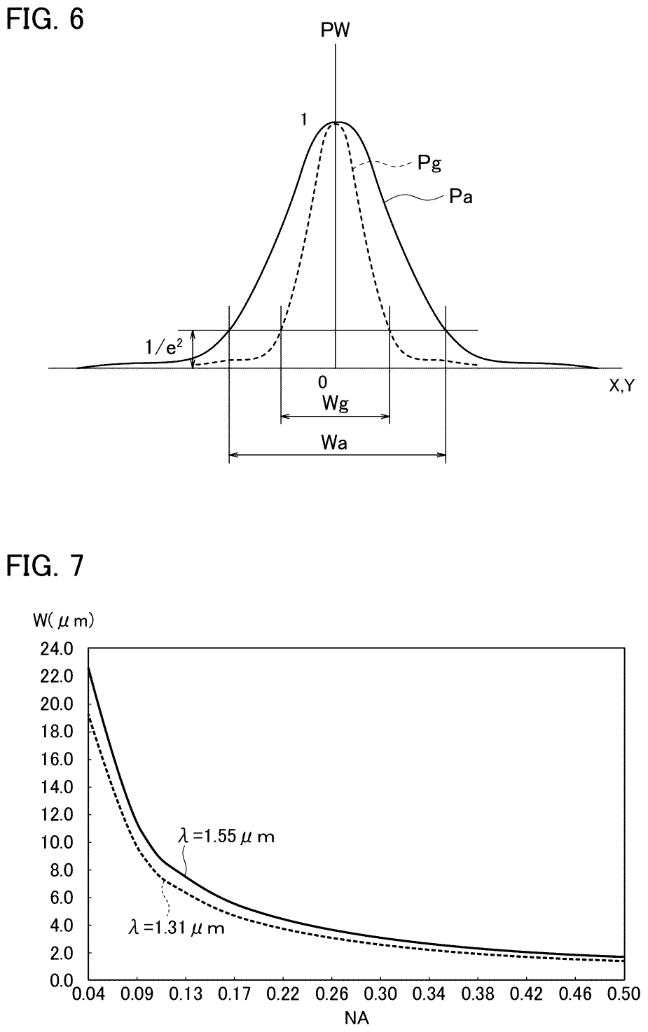

FIG. 6 illustrates a relationship between a mode field pattern Pa of an incident and emission light of the compound lens 11, and a mode field pattern Pg of an incident and emission light of the optical device 2. The mode field pattern Pa is set in such a way that the mode field diameter is slightly larger and the beam diameter is wider than those of the mode field pattern Pg. Therefore, even if the position of the optical axis of the beam diameter Wa of the compound lens 11 and the position of the optical axis of the beam diameter Wg of the optical signal L deviate due to the optical axis deviation in the XY direction, the region where the beam diameters overlap does not change. As a result, even if the connection efficiency slightly degrades, a fluctuation of the connection strength between the optical device 2 and the optical probe 10 does not occur. The intensity pattern of the compound lens 11 in the mode field depends on the numerical aperture NA related to the first curvature radius R1 and the first refractive index n1 of the first lens 111 on which the optical signal L is incident.

FIG. 7 is a graph illustrating a relationship between the numerical aperture NA and the beam diameter W. The beam diameter W becomes narrower as the numerical aperture NA becomes larger. The numerical aperture NA depends on the radiation angle 28 of the optical signal L and is expressed by NA=sin (8). The relationship of ε=tan⁻¹{λ/(π×W)} is obtained using the wavelength λ of the optical signal L and the beam diameter W.

For example, in a case of 2=1.55 μm and W=4 μm, “the radiation angle 2ε=28 degrees” is obtained when NA=0.24. Thus, in order to obtain the required beam diameter W, the numerical aperture NA corresponding to the beam diameter W is set.

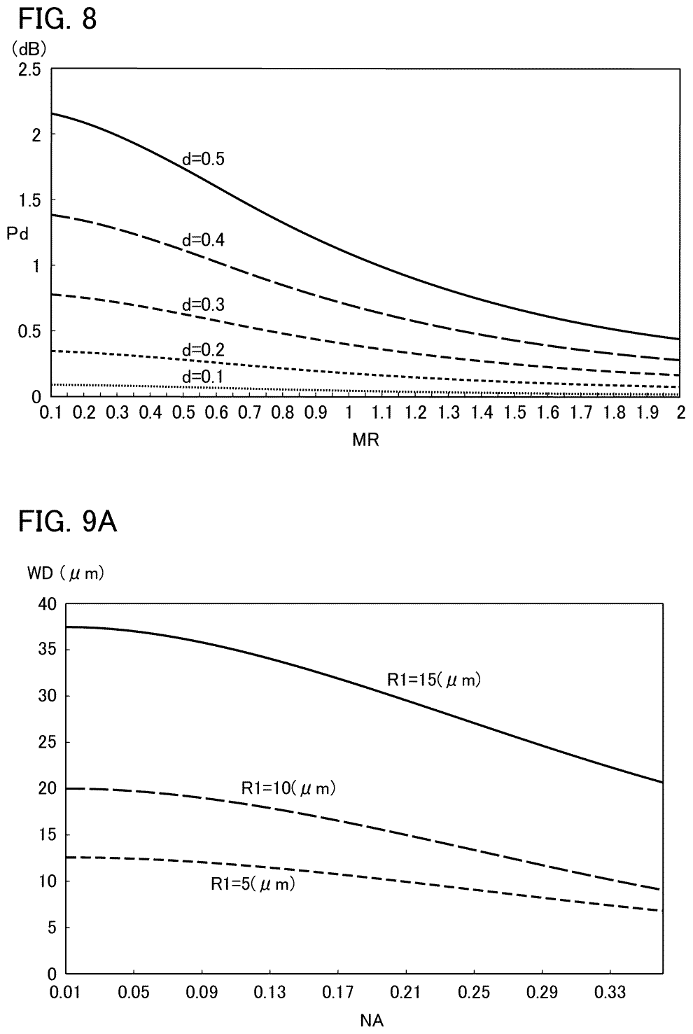

FIG. 8 is a graph illustrating a relationship between a ratio of the mode field diameter of the optical signal L to the mode field diameter of the optical probe 10 (MFD ratio MR) and a loss. FIG. 8 illustrates a loss Pd with MR=Wa/Wg as a horizontal axis by setting an optical axis deviation d=Wg1/Wg as a parameter, using a position deviation amount Wg1 of the optical axis of the beam diameter. As illustrated in FIG. 8, when the MFD ratio MR is larger than 1, the loss with respect to the optical axis deviation d in the XY direction is small. For example, when MR=1.5 and d=0.1 to 0.5, the loss is as small as about 0.1 to 0.7 dB, which suppresses a loss fluctuation due to the difference in the mode field diameter.

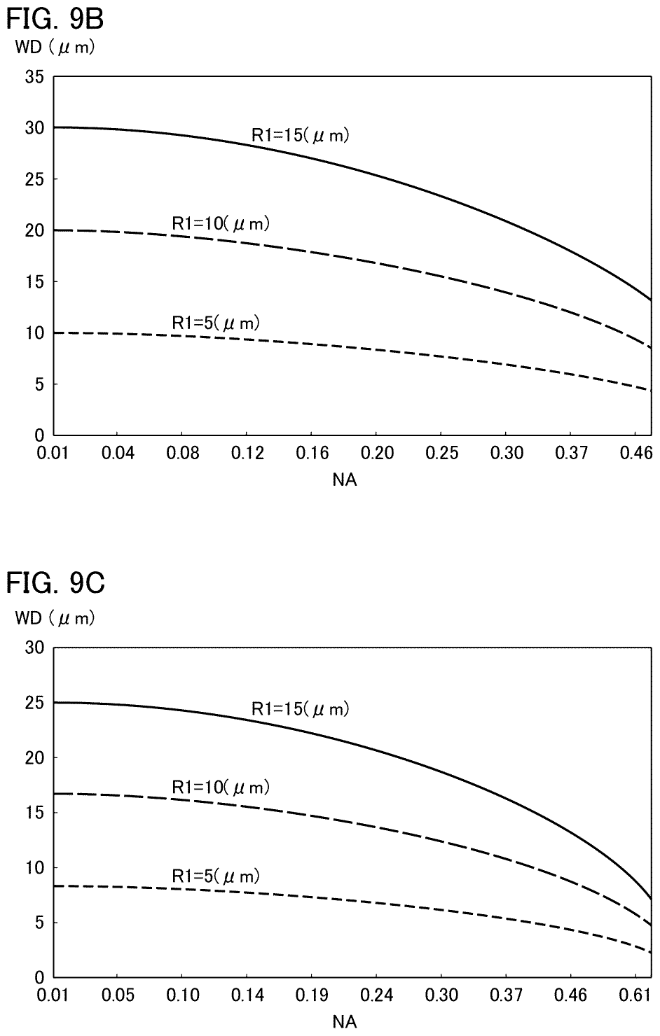

FIGS. 9A to 9C illustrate a relationship between numerical aperture NA and operating distance WD when the first curvature radius R1 is 5, 10, and 15 μm. FIG. 9A illustrates a case where the first refractive index n1 (refractive index of the compound lens 11) is 1.4, FIG. 9B illustrates a case where the first refractive index n1 is 1.5, and FIG. 9C illustrates a case where the first refractive index n1 is 1.6.

As illustrated in FIGS. 9A to 9C, in a case where the first curvature radius R1 is large, the working distance WD can be made large when the numerical aperture NA is the same. Further, in a case where the first refractive index n1 is small, the working distance WD can be made large when the numerical aperture NA is the same. In other words, as the refractive index of the first lens 111 becomes large and the curvature radius of the first lens 111 becomes small, the range in which the numerical aperture NA can be is made wider when the working distance WD is the same, resulting in stability. For example, in the compound lens 11 having a refractive index of 1.4, when the first curvature radius R1 is 10 μm, the second curvature radius R2 is 15 μm, and the wavelength λ is 1.55 μm, a loss characteristic of about 0.2 dB may be set in a case of NA=0.2, WD=15 μm, Wa=5 μm, Wg=4 μm, and MR=1.25.

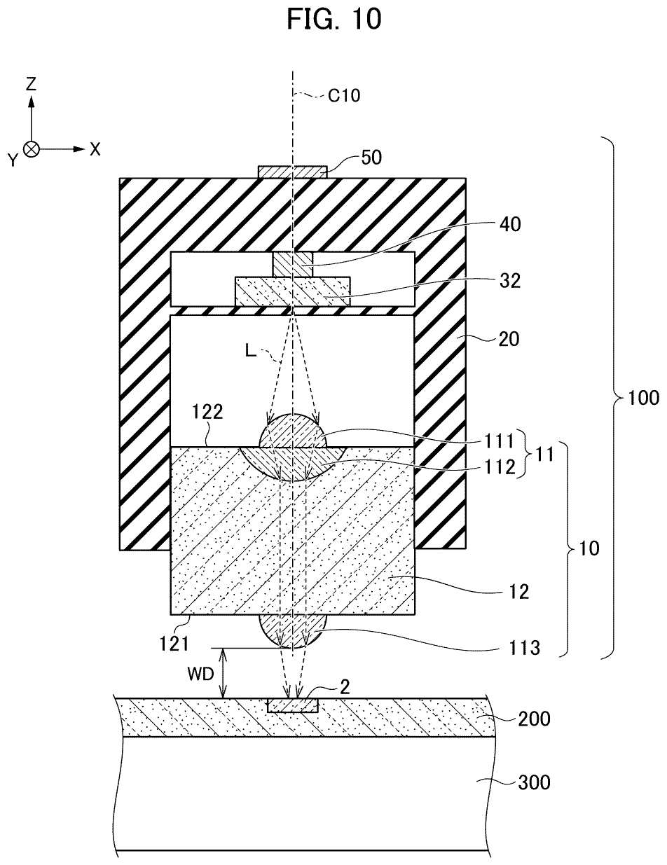

The above description is based on the case where the inspection optical module 100 includes the light receiving element 31, but as illustrated in FIG. 10, the inspection optical module 100 may include a light emitting element 32 as an optical element. In the inspection optical module 100 illustrated in FIG. 10, the compound lens 11 is disposed on the base end surface of the propagation path (second surface 122). An optical signal L is incident on the first lens 111 from the light emitting element 32, and the optical signal L propagated through the optical probe 10 is emitted from the tip surface (first surface 121) to the optical device 2.

As illustrated in FIG. 10, a third lens 113 may be disposed on the tip surface of the optical probe 10. For example, the spherical surface of the plano-convex third lens 113 disposed on the first surface 121 of the medium 12 is optically connected to the optical device 2. The optical signal L propagated through the medium 12 is condensed by the third lens 113, and the condensed optical signal L is emitted to the optical device 2.

In the inspection optical module 100 illustrated in FIG. 10, the optical axis of the optical signal L emitted from the light emitting element 32 gets closer to the optical axis C10 and is corrected parallel to the optical axis C10 by the compound lens 11 and the medium 12. Thereafter, the optical signal L which is propagated through the medium 12 parallel to the optical axis C10 penetrates the third lens 113 disposed on the tip surface of the optical probe 10, and is incident on the optical device 2. The numerical aperture NA of the optical device 2 is made larger than the numerical aperture NA of the third lens 113. Thus, the mode field diameter of the optical probe 10 is made slightly larger than that of the optical device, thereby making it possible to stabilize the connection characteristics between the optical probe 10 and the optical device 2.

As described above, the optical probe 10 according to the embodiment includes the compound lens 11 in which the first lens 111 having the first curvature radius R1 and the second lens 112 having the second curvature radius R2 are connected to each other, and the second lens 112 is embedded in the medium 12. By making the second curvature radius R2 larger than the first curvature radius R1 and embedding the second lens 112 in the medium 12 having a larger refractive index than the compound lens 11, the optical axis of the optical signal L in the medium 12 can be corrected in such a way as to be parallel to the optical axis C10 of the optical probe 10 and closer to the optical axis C10.

Further, the mode field pattern of the incident and emission light of the compound lens 11 is set to have a slightly larger mode field diameter than the mode field pattern of the incident and emission light of the optical device 2. Therefore, even if the position of the optical axis between the optical device 2 and the optical probe 10 deviates, the region where the beam diameters overlap does not change. As a result, a fluctuation of the connection strength between the optical device 2 and the optical probe 10 does not occur.

As described above, the optical probe 10 makes it possible to correct the optical axis of the optical signal L inside the optical probe 10 so as to be parallel to the optical axis C10. Further, even if an angular deviation occurs, it can be converted into a position deviation. In addition, the position of the optical axis of the optical signal L can be closer to the optical axis C10 inside the optical probe 10 compared to the first passing point P1. Furthermore, even if the position of the optical axis deviates between the optical device 2 and the optical probe 10, a fluctuation of the connection strength between the optical device 2 and the optical probe 10 does not occur. Accordingly, in order to perform an alignment of the optical probe 10 and the optical device 2, it is not necessary to perform two alignment steps, which are a coarse movement position adjustment using an actuator capable of adjusting six-axis degrees of freedom and a precise position adjustment of submicron order. For example, it is possible to perform an alignment of the optical probe 10 and the optical device 2 by adjusting only the position of the XYZ axes and by adjusting three to four degrees of freedom in the rotation adjustment of the Z axis. Therefore, the optical probe 10 and the inspection optical module 100 make it possible to suppress the time required for alignment of the optical probe 10 and the optical device 2, and suppress an increase and a fluctuation in a connection loss.

An example of a manufacturing method of the optical probe 10 will be described below.

As the medium 12, for example, a silicon substrate having a refractive index of about 3.4 may be used. In order to form a spherical recess for embedding the second lens 112 in the medium 12, a photolithography technique can be employed as follows. For example, a mask with minute holes is disposed on the surface of the silicon substrate, and a spherical recess is formed in the medium 12 by anisotropic etching using an alkaline solution. As an alkaline solution, potassium hydroxide (KOH), tetramethyl ammonia hydroxide (TMAH), and the like are used.

Thereafter, in order to form the second lens 112, a translucent resin material such as a silicon-based resin having a refractive index of 1.4 to 1.6 or a transparent polymer having a refractive index of 1.4 to 1.6 is filled in the recess formed in the silicon substrate. Next, the first lens 111 is formed. Various methods are possible for manufacturing the first lens 111, and one of the methods will be described below as an example. A thin film sheet such as a transparent polymer is formed by using an arrayed hemispherical precision mold, and then the material is dropped thereon by an inkjet and processed into a spherical shape by a meniscus. Next, the thin film sheet is accurately positioned on the surface of the silicon substrate on which the second lens 112 is formed, and the first lens 111 is disposed thereon. Alternatively, after a recess may be formed in the silicon substrate, the resin material may be dropped therein by an inkjet, and then the compound lens 11 is formed by a precision mold.

It is also possible to manufacture the optical probe 10 by means of a micro optical manufacturing method using an ultrafine 3D printer. Alternatively, the optical probe 10 may be manufactured by using a silicon oxide film (SiO₂) substrate. Accordingly, various methods can be selected for forming the optical probe 10.

In manufacture of the optical probe 10, a substrate on which a plurality of compound lenses 11 are formed may be cut by a dicing saw or the like according to the required configuration, and may be singulated. It is preferable to apply anti-reflection (AR) coating using a dielectric multilayer film in a state of a substrate as a countermeasure against reflected return light or stray light, which are problems in the measurement of the optical device 2.

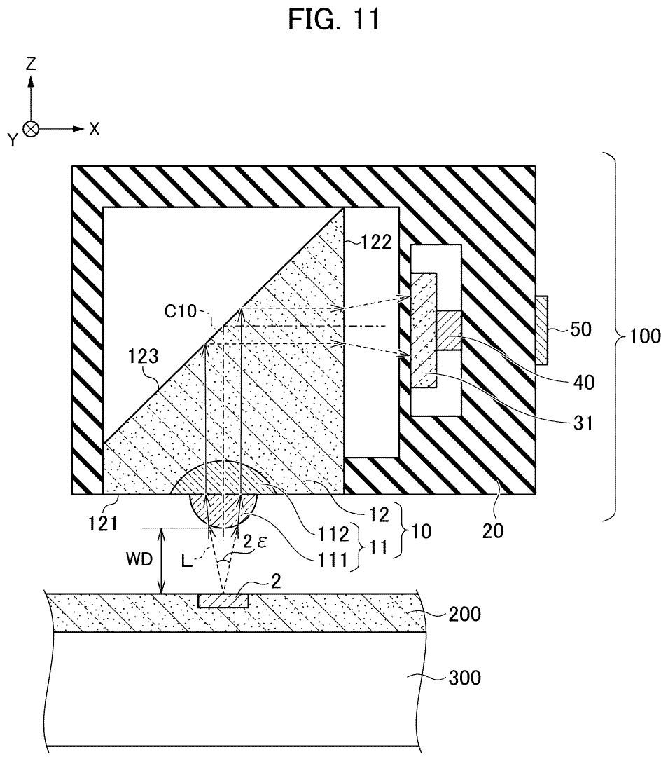

The direction of the optical axis C10 may be changed inside the optical probe 10. For example, as illustrated in FIG. 11, the optical probe 10 may have an optical path changing structure which changes the optical axis of the optical signal L by 90 degrees inside the medium 12. In the inspection optical module 100 illustrated in FIG. 11, in order to change the optical axis of the optical signal L by 90 degrees, a specular-like reflecting surface 123 forming an angle of 45 degrees in the extending direction of the optical axis C10 is formed on the micro-prism-like medium 12. The opposite side of the reflecting surface 123 is an air layer. The operation of the inspection optical module 100 illustrated in FIG. 11 is same as the operation which has been described with reference to FIGS. 1 to 3.

According to the inspection optical module 100 illustrated in FIG. 11, the light receiving element 31 or the light emitting element 32 may be provided in a direction crossing the optical axis of the incident and emission light of the optical device 2 (for example, 90 degrees). Therefore, it is possible to provide flexibility in the mounting of the inspection optical module 100. For example, the space in the height direction can be reduced. In addition, since the main surface of the electrode pad 50 faces in the lateral direction, it is also possible to facilitate the electrical connection of the electrode pad 50 with the wiring pattern on the circuit board using wire bonding or soldering.

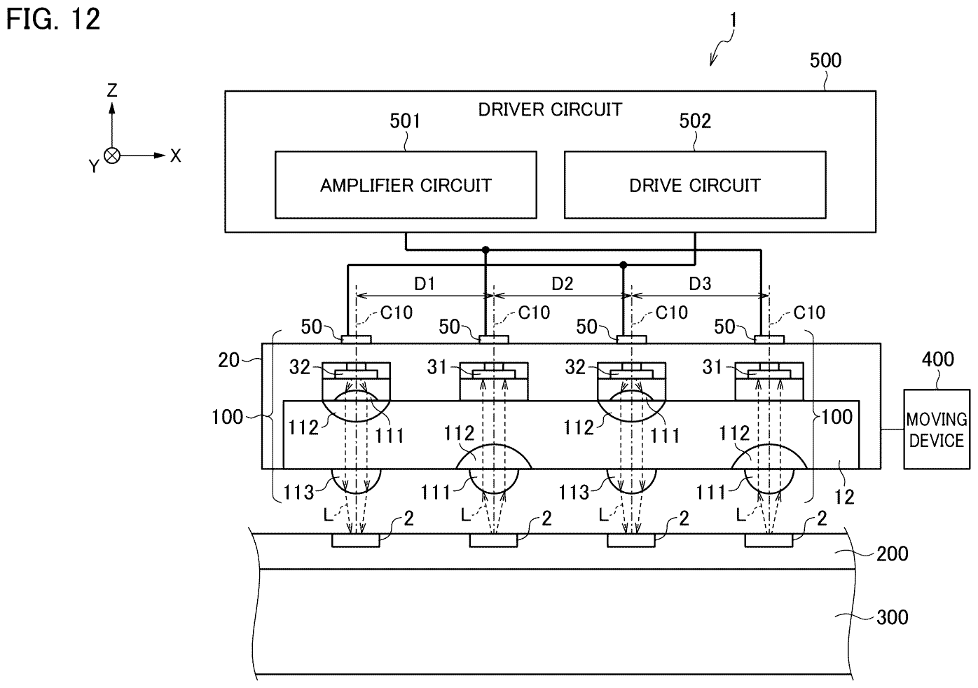

FIG. 12 illustrates a configuration example of a measurement system 1 including a plurality of inspection optical modules 100. In the measurement system 1 illustrated in FIG. 12, the plurality of inspection optical modules 100 are configured using one medium 12. In other words, a plurality of compound lenses 11 are disposed on a single medium 12. Alternatively, each of the plurality of inspection optical modules 100 may be configured using an individual medium 12.

FIG. 12 illustrates a configuration example of the measurement system 1 including two inspection optical modules 100 each including the light receiving element 31, and two inspection optical modules 100 each including the light emitting element 32. However, a type of an optical element included in the measurement system 1 may be set optionally. For example, each of the inspection optical modules 100 in the measurement system 1 may include the light receiving element 31, or each of the inspection optical modules 100 in the measurement system 1 may include the light emitting element 32.

The distances D1 to D3 between the inspection optical modules 100 disposed in the measurement system 1 may be set to about 100 μm to 500 μm, for example. In addition, the number and arrangement of the inspection optical modules 100 included in the measurement system 1 may be set optionally. For example, the inspection optical modules 100 may be arranged in an array along the X-axis direction and the Y-axis direction.

The measurement system 1 includes a moving device 400 capable of precisely adjusting the position of the support medium 20 for alignment of the tip surface of the optical probe 10 and the optical device 2. The support medium 20 may move in each direction, that is, in the X-axis direction, in the Y-axis direction, and in the Z-axis direction under the control of the moving device 400. For example, the moving device 400 moves the support medium 20 along a plane surface parallel to the first surface 121, thereby aligning the optical axis of the optical probe 10 and the optical axis of the optical signal L. Further, the moving device 400 may move the support medium 20 in the Z-axis rotation direction. If the stage 300 on which the semiconductor wafer 200 is disposed has a position adjustment mechanism, the moving device 400 may not be necessarily provided. For example, a method can be employed in which it is possible to move the stage 300 in the XYZ-axes direction and in the Z-axis rotation direction by fixing the position of the support medium 20. Thus, an alignment of the optical probe 10 and the optical device 2 is possible in the measurement system 1. Alternatively, the support medium 20 may move in the X-axis direction and the Y-axis direction, and the stage 300 may move in the Z-axis direction. Various adjustment methods can be employed for the alignment of the optical probe 10 and the optical device 2.

The measurement system 1 includes a driver circuit 500 that drives the light receiving element 31 and the light emitting element 32. The driver circuit 500 includes, for example, an amplifier circuit 501 and a drive circuit 502. The amplifier circuit 501 amplifies an electric signal photoelectrically converted by the light receiving element 31 and transmits it to a measurement device (not illustrated). The drive circuit 502 supplies power to the light emitting element 32 under the control of the measurement device to drive the light emitting element 32.

Further, the support medium 20 and the driver circuit 500 may be integrally mounted on a multilayer substrate-like module such as a probe card and mounted on the prober. This makes it possible to measure the optical device 2 using the prober.

The measurement system 1 may include an electric probe to which a current or voltage is applied to drive the optical device 2. In this case, the alignment of the optical probe 10 and the optical device 2 and the alignment of the electric probe and the optical device 2 may be performed independently, or the optical probe 10 and the electric probe may be integrally configured to perform the alignment. Since the optical probe 10 has a large tolerance for the position deviation amount and the angular deviation amount, a high accuracy of sub-micron order is not required for the alignment of the electric probe and the optical device 2, thereby making it possible to reduce a connection loss even in the alignment of micron order.

After the alignment of the optical probe 10 and the optical device 2, an optical signal is propagated through the measurement system 1 illustrated in FIG. 12 to measure the optical device 2. For example, the optical signal L emitted from the optical device 2 is received by the light receiving element 31 via the optical probe 10. Alternatively, the optical signal L emitted from the light emitting element 32 propagates through the optical probe 10 and is incident on the optical device 2 on the semiconductor wafer 200.

According to the measurement system 1 illustrated in FIG. 12, the optical axis of the incident and emission light of the optical signal L is corrected by the optical probe 10, and by setting the mode field diameter of the optical probe 10 slightly larger than the mode field diameter of the optical signal L, a tolerance can be ensured for deviation in the XY plane surface. This makes it possible to facilitate an optical connection between the optical signal L and the inspection optical module 100, thereby stably performing measurement of the optical device 2 by the optical signal L which is incident and emitted. Further, the measurement operation performed by precise adjustment of the position and angle of the optical probe 10 using an actuator capable of adjusting six-axis degrees of freedom is unnecessary. Thus, for example, the inspection optical module 100 can be mounted on and fixed directly to the probe card mounted on the prober, thereby performing the measurement of the optical device 2 only by the position adjustment operation in the XYZ-axes direction and in the Z-axis rotation direction using the prober.

### Other Embodiments

The embodiment of the present invention has been described above, but the statements and drawings forming part of this disclosure should not be understood as limiting the invention. Various alternative embodiments, examples, and operating techniques will be apparent to those skilled in the art from this disclosure.

For example, a description has been given to the case where the optical axis C10 of the optical probe 10 is parallel to the normal direction of the main surface of the semiconductor wafer 200. Meanwhile, when the optical signal L is emitted obliquely with respect to the normal direction of the main surface of the semiconductor wafer 200, the optical probe 10 may be disposed so as to incline the optical axis direction by aligning the tip surface with the traveling direction of the optical signal L.

It should be understood that the present invention includes various embodiments not described herein.

What is claimed is:

1. An optical probe which transmits and receives an optical signal to and from an optical device, comprising:
a medium through which the optical signal propagates;
a plano-convex first lens disposed on a first surface of the medium with a bottom surface facing the medium; and
a plano-convex second lens which constitutes a compound lens in which a bottom surface of the second lens is connected to the bottom surface of the first lens by aligning an optical axis of the second lens and an optical axis of the first lens, the second lens being embedded in the medium and having a curvature radius of a convex surface larger than that of the first lens, wherein
a refractive index of the medium is larger than a refractive index of the compound lens.

2. The optical probe according to claim 1, wherein
when an angle formed by a traveling direction of the optical signal in the compound lens and the first surface is defined as γ,
when an angle formed by a straight line passing through a point where the optical signal passes through a boundary between the second lens and the medium and a center of a spherical surface of the second lens, and an optical axis of the compound lens is defined as φ,
when a refractive index of the compound lens is defined as n1, and
when a refractive index of the medium is defined as n2,
a relationship of (π/2−γ+φ)−sin⁻¹ {n2/n1×sin(φ)}=0 is satisfied.

3. The optical probe according to claim 1, wherein the medium is a silicon-based material.

4. The optical probe according to claim 1, further comprising an optical path changing structure which changes an optical axis of the optical signal by 90 degrees inside the medium.

5. An inspection optical module, comprising:
an optical probe which transmits and receives an optical signal to and from an optical device, the optical probe comprising: a medium through which the optical signal propagates; a plano-convex first lens disposed on a first surface of the medium with a bottom surface facing the medium; and a plano-convex second lens which constitutes a compound lens in which a bottom surface of the second lens is connected to the bottom surface of the first lens by aligning an optical axis of the second lens and an optical axis of the first lens, the second lens being embedded in the medium and having a curvature radius of a convex surface larger than that of the first lens, wherein a refractive index of the medium is larger than a refractive index of the compound lens; and
an optical element optically connected to the optical probe, wherein
a tip surface of a propagation path of the optical signal in the optical probe is opposed to the optical device, and
the optical element is disposed opposite to a base end surface of the propagation path.

6. The inspection optical module according to claim 5, wherein
the compound lens is disposed on the tip surface, and the first lens is opposed to the optical device, and
the optical element is a light receiving element which receives the optical signal emitted from the optical device, incident on the compound lens, and propagated through the medium.

7. The inspection optical module according to claim 5, wherein
the compound lens is disposed on the base end surface, and the first lens is opposed to the optical element,
the optical element is a light emitting element which makes the optical signal incident on the optical probe, and
the optical signal propagated through the optical probe is emitted to the optical device.

8. The inspection optical module according to claim 7, further comprising
a third lens disposed on the tip surface, wherein
the optical signal propagated through the medium is condensed by the third lens and emitted to the optical device.

9. A measurement system, comprising:
an inspection optical module comprising: an optical probe which transmits and receives an optical signal to and from an optical device, the optical probe comprising: a medium through which the optical signal propagates; a plano-convex first lens disposed on a first surface of the medium with a bottom surface facing the medium; and a plano-convex second lens which constitutes a compound lens in which a bottom surface of the second lens is connected to the bottom surface of the first lens by aligning an optical axis of the second lens and an optical axis of the first lens, the second lens being embedded in the medium and having a curvature radius of a convex surface larger than that of the first lens, wherein a refractive index of the medium is larger than a refractive index of the compound lens; and an optical element optically connected to the optical probe, wherein a tip surface of a propagation path of the optical signal in the optical probe is opposed to an optical device, and the optical element is disposed opposite to a base end surface of the propagation path;
a support medium which supports the optical probe; and
a moving device which moves the support medium for alignment of the optical probe and the optical device.

10. The measurement system according to claim 9, wherein the moving device moves the support medium parallel to the first surface to align an optical axis of the optical probe and an optical axis of the optical signal.

11. The measurement system according to claim 9, further comprising a plurality of inspection optical modules.

12. The measurement system according to claim 11, wherein a plurality of compound lenses are disposed on a single medium.
